(19) United States
(12) Patent Application Publication
(10) Pub. No.: US 2021/0188197 A1
(43) Pub. Date: Jun. 24, 2021

(54) PLACARD HOLDER

(71) Applicant: Miguel Octavio Gaitan, Philadelphia, PA (US)

(72) Inventor: Miguel Octavio Gaitan, Philadelphia, PA (US)

(21) Appl. No.: 17/196,951

(22) Filed: Mar. 9, 2021

(51) Int. Cl. B60R 13/10; G09F 7/18; G09F 21/04

(52) U.S. Cl. CPC B60R 13/105; G09F 2007/1843; G09F 21/048; G09F 7/18

(57) ABSTRACT

Disclosed is a placard holder that protects a placard from winds and weathering. The placard holder includes a plate of a square or cuboidal dimension. The plate has a top edge, a right edge, a bottom edge, a left side, a front face, and a rear face. Two elongated bars are coupled on the top face and run along the left side and the right side of the plate. A crossbar is attached on the top face of the plate, running along its rear side, wherein the two bars and the crossbar form a three-sided frame. Plexiglass of dimension proportional to the plate attached to the frame, wherein the front edge of the plate and the adjacent edge of the plexiglass forms an opening. A placard can be inserted between the plate and the plexiglass through the opening and retained by the frame on three sides.

### FIELD OF INVENTION

The present invention relates to a placard holder, and more particularly the present invention relates to a weather-resistant placard holder.

### BACKGROUND

A placard is typically a sign displayed in a public place to indicate information about the vehicle operator or contents of a vehicle or building. The placard can be a small sign attached to a vehicle or building. For example, the placard can be a sticker that can be pasted on a vehicle at a visible place. Vehicles carrying hazardous material or inflammable materials must have the recommended sign on a visible outer area.

However, placards have a drawback that they get torn, weathered, or fade. The weathered signs may not be visible clearly, thus a need is appreciated for a placard holder that could protect the placard from getting torn or weathered.

### SUMMARY OF THE INVENTION

The principal object of the present invention is therefore directed to a placard holder that protects the placard from the wind.

It is another object of the present invention that the placard holder protects the placard from weathering.

It is yet another object of the present invention that the placard holder displays the placard with high clarity.

In one aspect, the placard holder comprises a plate of a square or cuboidal shape. The plate has a top edge, a right edge, a bottom edge, a left side, a front face, and a rear face. Two thin and elongated bars are coupled on the top face and along its left side and the right side of the plate. A crossbar is coupled on the top face of the plate and along its rear side, wherein the two bars and the crossbar forms a three-sided frame. Plexiglass of a size proportional to the size of the plate attached to the frame, wherein the front edge of the plate and the adjacent edge of the plexiglass form an opening. A placard can be inserted between the plate and the plexiglass through the opening and retained by the frame on three sides.

These and other objects and advantages of the embodiments herein will become readily apparent from the following detailed description taken in conjunction with the accompanying drawings.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a placard holder, according to an exemplary embodiment of the present invention.

FIG. 2 shows an exploded view of the placard holder of FIG. 1, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

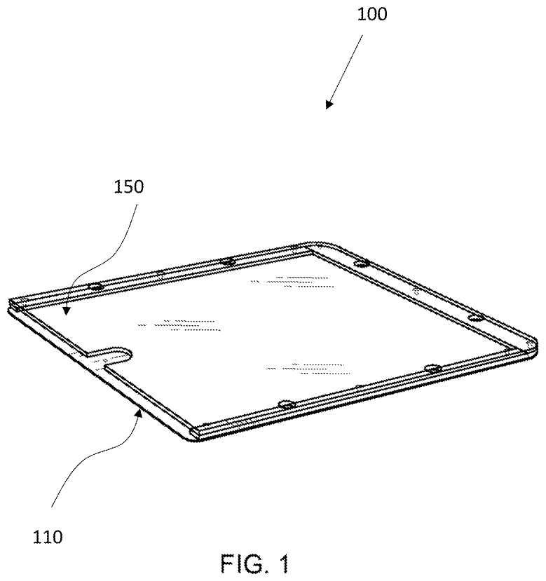

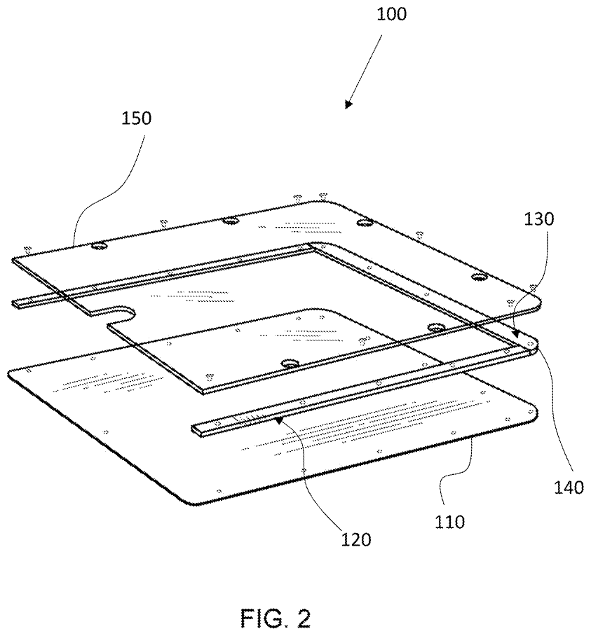

Referring to FIGS. 1 and 2 which shows an exemplary embodiment of the placard holder 100. The placard holder shown in FIG. 1 is of a square dimension having a top side, a bottom side, a left side, a right side, a front face, and a bottom face. The placard holder can be compact and durable. It is to be understood that FIG. 1 shows the placard holder as square, however, the placard holder can be rectangular, triangular, or polygonal. Moreover, the one or more corners of the placard holder can be round.

The placard holder 100 is having a plate 110 that is made of a rigid and durable material, such as steel or aluminum. Preferably, the material of the plate can be corrosion resistant. In one implementation, the plate is square having a length of about 12 inches. The plate can be made thinner depending upon the durability of the material of the plate. The plate can have at least four apertures near its corners for installing the placard holder to a wall or a vehicle. For example, the placard holder can be installed using rivets, wherein the rivets may pass through the apertures in the plate. The apertures can be provided anywhere near the edge of the plate. The plate has a top edge, a bottom edge, a left edge, a right edge, a front face, and a bottom face.

The placard holder further having three thin bars of an elongated rectangular shape. The two bars 120 coupled over the top face of the plate at its boundary and run along the left edge and the right edge of the plate. The two bars can be about 10.75 inches in length and 0.5 inches in width. The thickness of the two bars can be proportional to the thickness of a placard or any paper or cardboard for displaying in the disclosed placard holder. In one case, the two bars can be 0.125 inches thick. The bars can be made of the same material as the plate or similar material. For example, the bars can be made of Aluminum. The third bar 130 can be a crossbar that is attached at the rear edge of the plate. The crossbar and the two bars form a frame 140 around three sides of the plate. The crossbar can be about 12 inches in length i.e. the length of the rear edge of the plate. The thickness and the width of the crossbar is the same as the thickness and the width of the two bars.

Furthermore, it can be seen in FIG. 1 is a plexiglass 150 on top of the assembly. The plexiglass provides a clear view of a placard sandwiched between the plexiglass and the plate. The plexiglass can be of a dimension similar to the plate and coupled on top of the frame i.e. the three bars. The plexiglass, the frame, and the plate can be bonded using fasteners, such as rivets. FIGS. 1 and 2 shows holes near edges that can allow a rivet to pass through bonding the plexiglass, the frame, and the plate. The Plexiglass, the frame, and the plate form an enclosure for receiving a placard, wherein the front edge of the plate and adjacent edge of the plexiglass forms an opening of the enclosure for receiving the placard. In one implementation, the plexiglass can be 12 inches and 11.5 inches in length and width. The thickness can be about 0.125 inches. It is to be understood that the size of the disclosed placard holder can be proportional to the size of the placard to be carried by the placard holder. The square placard holder of 12 inches long can receive a placard of up to 11 inches. Similarly, the thickness of the frame can be proportional to the thickness of the placard, such as a placard can slide into the placard assembly.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A placard holder comprising:
a plate having a front edge, a left edge, a rear edge, a right edge, a top face, and a bottom face, size of the plate is proportional to the size of a placard;
a frame coupled over the top face of the plate, the frame comprises two parallel bars and a crossbar, the two parallel bars run along the left edge and the right edge of the plate, the crossbar runs along the rear edge of the plate, the two parallel bars and the crossbar are continuous; and
a plexiglass coupled over the frame, the plexiglass of a size proportional to the size of the plate,
wherein the plexiglass, the frame, and the plate forms an enclosure for receiving the placard, the front edge of the plate and an edge of the plexiglass adjacent to the front edge of the plate forms an opening of the enclosure.

2. The placard holder according to claim 1, wherein the two parallel bars and the crossbar are about 0.5 inches wide.

3. The placard holder according to claim 1, wherein the two parallel bars and the crossbars are 0.125 inches thick.

4. The placard holder according to claim 1, wherein the plexiglass, the frame, and the plate are fastened using a plurality of rivets.

5. The placard holder according to claim 1, wherein the plate is having a plurality of apertures near its corner for mounting the placard holder to a vehicle.

6. The placard holder according to claim 1, wherein the enclosure includes the placard.

7. The placard holder according to claim 1, wherein the plate and the frame are made of Aluminum.

8. The placard holder according to claim 1, wherein the plate is square of a length about 12 inches.

9. The placard holder according to claim 8, wherein the Plexiglass is about 12 inches in length and about 11.5 inches in width.

10. The placard holder according to claim 9, wherein the two parallel bars are 11.75 inches in length and 0.5 inches in width, the crossbar is 12 inches in length and 0.5 inches in width.

11. The placard holder according to claim 10, wherein the plexiglass and the frame are 0.125 inches thick.
